(19) United States
(12) Patent Application Publication
(10) Pub. No.: US 2021/0392691 A1
(43) Pub. Date: Dec. 16, 2021

(54) SYSTEM AND METHOD FOR RANDOM ACCESS IN WIRELESS NETWORK

(71) Applicant: Telefonaktiebolaget LM Ericsson (publ), Stockholm (SE)

(72) Inventors: Min Wang, Luleå (SE); Jinhua Liu, Beijing (CN)

(21) Appl. No.: 17/290,619

(22) PCT Filed: Oct. 29, 2019
(86) PCT No.: PCT/CN2019/114022

§ 371 Date: Apr. 30, 2021

(30) Foreign Application Priority Data
Oct. 30, 2018 (CN) PCT/CN2018/112728

(51) Int. Cl. H04W 74/08

(52) U.S. Cl. CPC H04W 74/0833

(57) ABSTRACT

A method at a terminal device is provided. The method comprises selecting a cell from a random access, RA, cell group, wherein the RA cell group comprises a number of cells for unlicensed spectrum from which the terminal device to choose for random access; transmitting an RA request in the selected cell; and detecting an RA response from a cell within the RA cell group.

### TECHNICAL FIELD

The disclosure relates generally to wireless communications, and more particularly, to systems and methods for random access in a wireless network.

### BACKGROUND

Next generation systems are expected to support a wide range of use cases with varying requirements ranging from fully mobile devices to stationary IoT (Internet of Things) or fixed wireless broadband devices. The traffic pattern associated with many use cases is expected to consist of short or long bursts of data traffic with varying length of waiting period.

In order to tackle with the ever increasing data demanding, New Radio (NR) technology is considered to use both licensed and unlicensed spectrum. Accordingly, both license assisted access(LAA) and standalone unlicensed operation shall be supported in NR.

### SUMMARY

For NR unlicensed spectrum, Random Access (RA) procedure and scheduling procedure shall be improved for NR standalone scenario so as to ensure differentiated latency requirements. In the proposed schemes, UL/DL cells for cross-carrier RA procedure are linked and the UE can select UL/DL cells for PRACH preamble transmission and RA response (RAR) monitoring.

In an aspect of the disclosure, a method at a terminal device is provided. The method comprises selecting a cell from a random access, RA, cell group. The RA cell group comprises a number of cells for unlicensed spectrum from which the terminal device to choose for random access. The method further comprises transmitting an RA request in the selected cell. The method further comprises detecting an RA response from a cell within the RA cell group.

In an embodiment, the method may further comprise receiving configuration of the RA cell group. The configuration may be based on at least one of carrier frequency band of cells, measurement results of radio channel quality indicators of cells, and geography locations of cells.

In an embodiment, the method may further comprise switching to another cell within the RA cell group to retransmit the RA request if the transmission of the RA request fails.

In an embodiment, the method may further comprise performing power ramping after switching to the other cell within the RA cell group.

In an embodiment, the method may further comprise switching to another cell within the RA cell group to retransmit the RA request upon reception of a back off indicator.

In an embodiment, a default RA cell group may be configured if the UE is in ‘RRC IDLE’ state, or the RA cell group may be configured via dedicated RRC signaling if the UE is in ‘RRC Connected’ state.

In an embodiment, each cell of the RA cell group may be configured with at least one of PRACH configuration and common search space configuration.

In an embodiment, monitoring an RA response in a cell within the RA cell group may comprise stopping the monitoring after reception of the first RA response in a cell, or monitoring, after reception of the first RA response in a cell, other RA responses in other cells until the RA response window expires.

In an embodiment, multiple grants may be used to transmit multiple Msg3 messages if Listen-Before-Talk (LBT) operations for all of the multiple grants succeed.

In an embodiment, high priority information may be duplicated in the multiple grants.

In an embodiment, Radio Link Failure, RLF, is not triggered even if the maximum number of RA attempts has been reached, provided that there is still other cell available in the RA cell group.

In an embodiment, all of the cells in the RA cell group belong to a same timing advance, TA, group.

In a further aspect of the disclosure, a method at a network node is provided. The method comprises receiving a random access, RA, request in a cell within an RA cell group. The RA cell group comprises a number of cells for unlicensed spectrum from which a terminal device to choose for random access. The method further comprises transmitting an RA response in a cell within the RA cell group.

In an embodiment, the method may further comprise transmitting configuration of the RA cell group to the terminal device.

In an embodiment, multiple RA responses may be transmitted in different cells in the RA cell group. The multiple RA responses may carry grants with a same size or different sizes.

In an embodiment, the method may further comprise receiving multiple Msg3 messages with grants, wherein high priority information is duplicated in the grants.

In an embodiment, the method may further comprise receiving a Radio Link Failure, RLF, report, and adjusting the RA cell group based on the received RLF report.

In a further aspect of the disclosure, a terminal device is provided which comprises a processor and a memory coupled to the processor. The memory contains instructions executable by the processor whereby the terminal device is operative to perform the methods in accordance with the aspects of the disclosure.

In a further aspect of the disclosure, a network node is provided which comprises a processor and a memory coupled to the processor. The memory contains instructions executable by the processor whereby the network node is operative to perform the methods in accordance with the aspects of the disclosure.

In a further aspect of the disclosure, a computer program comprising computer program code means is provided. The computer program code means may cause, when executed on a processor, the processor to perform the methods in accordance with the aspects of the disclosure.

In a further aspect of the disclosure, a computer readable storage medium is provided. The computer readable storage medium has stored thereon the computer program in accordance with the aspects of the disclosure.

With the proposed schemes of the disclosure, performance of RA with optimized latency management can be optimized and radio connection maintenance in unlicensed spectrum is enhanced. Moreover, negative impact due to LBT failure on UL data transfer and UL RACH performance is eliminated.

### BRIEF DESCRIPTION OF THE DRAWINGS

The schemes herein are illustrated, by way of example and not by way of limitation, in the figures of the accompanying drawings in which like references indicate similar elements. In the drawings,

FIG. 1A is a schematic showing a 4-step RA procedure;

FIG. 1B is a schematic showing a 2-step RA procedure;

FIG. 2 is a flowchart illustrating a method at a terminal device according to an embodiment of the disclosure;

FIG. 3 is a flowchart illustrating a method at a network node according to an embodiment of the disclosure;

FIG. 4 is a block diagram of a terminal device according to an embodiment of the disclosure;

FIG. 5 is a block diagram of a network node according to an embodiment of the disclosure; and

FIG. 6 is a block diagram of a computer readable storage medium having stored thereon a computer program comprising computer program code means according to an embodiment of the disclosure.

### DETAILED DESCRIPTION

In the discussion that follows, specific details of particular embodiments of the present disclosure are set forth for purposes of explanation and not limitation. It will be appreciated by those skilled in the art that other embodiments may be employed apart from these specific details. Furthermore, in some instances detailed descriptions of well-known methods, nodes, interfaces, circuits, and devices are omitted so as not to obscure the description with unnecessary detail. Those skilled in the art will appreciate that the functions described may be implemented in one or several nodes.

It should be noted that references to “an” or “one” or “some” embodiment(s) in this disclosure are not necessarily to the same embodiment, and such references refer to at least one embodiments.

As used herein, the term “terminal device” refers to any device that can access a wireless communication network and receive services therefrom. By way of example and not limitation, the terminal device may include, but is not limited to, a mobile phone, a cellular phone, a smart phone, a tablet, a wearable device, a personal digital assistant (PDA), and the like.

The term “network node” used herein refers to a device at the network side and may include a network device via which a terminal device accesses the network and receives services therefrom. By way of example, such a network node may be a base station (BS), a node B (NodeB or NB), an evolved NodeB (eNodeB or eNB), a gNB, a Remote Radio Unit (RRU), a radio header (RH), a remote radio head (RRH), a relay, a low power node such as a femto, a pico, and so forth.

Because both license assisted access and standalone unlicensed operation are to be supported in NR, the procedure of PRACH transmission and/or scheduling request (SR) transmission in unlicensed spectrum shall be provided. 3GPP has defined a study item on NR-based Access to Unlicensed Spectrum. At this study item, compared to the LTE LAA, NR-Unlicensed Spectrum (NR-U) also needs to support dual connectivity (DC) and standalone scenarios, where the MAC procedures including RACH and scheduling procedure on unlicensed spectrum are subject to the Listen-Before-Talk (LBT) failures.

LBT is designed for unlicensed spectrum co-existence with other RATs. In this mechanism, a radio device applies a clear channel assessment (CCA) check before any transmission. The transmitter involves energy detection (ED) over a time period compared to a certain threshold (ED threshold) in order to determine if a channel is idle. In case the channel is determined to be occupied, the transmitter performs a random back-off within a contention window before next CCA attempt. In order to protect the ACK transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MCOT)). For QoS differentiation, a channel access priority based on the service type has been defined. For example, there are four LBT priority classes defined for differentiation of contention window sizes (CWS) and MCOT between services.

In licensed spectrum, a terminal device (such as a UE) may measure Reference Signal Received Power (RSRP) and Reference Signal Received Quality (RSRQ) of the downlink radio channel, and provide the measurement reports to its serving eNB/gNB. However, they don't reflect the interference strength on the carrier. Another metric Received Signal Strength Indicator (RSSI) can be used for such purpose. At the eNB/gNB side, it is possible to derive RSSI based on the received RSRP and RSRQ reports; however, this requires that they must be available. Due to the LBT failure, some reports in terms of RSRP or RSRQ may be blocked (can be either due to that the reference signal transmission (DRS) is blocked in the downlink or the measurement report is blocked in the uplink). Hence, the measurements in terms of RSSI are very useful. The RSSI measurements together with the time information concerning when and how long time that UEs have made the measurements can assist the gNB/eNB to detect the hidden node. Additionally, the gNB/eNB can measure the load of the carrier which is useful for the network to prioritize some channels for load balance and channel access failure avoidance.

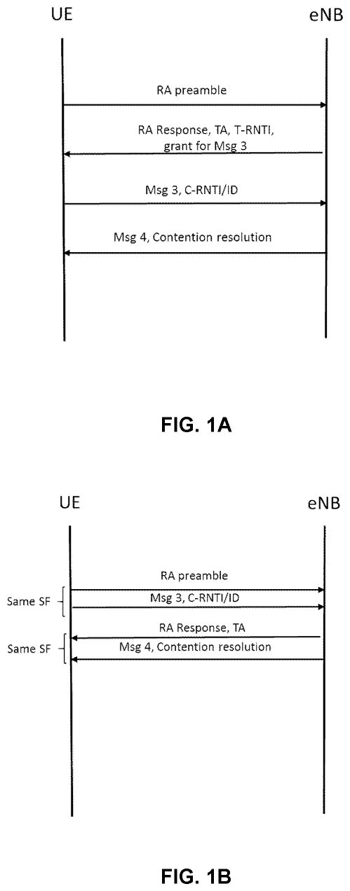

FIG. 1A is a schematic showing a 4-step RA procedure for wireless systems such as LTE and NR Rel-15. As shown in FIG. 1A, the UE randomly selects a preamble which is transmitted. When the eNB detects the preamble, it estimates the Timing alignment (TA) the UE should use in order to obtain UL synch at the eNB. The eNB responds with the TA, a grant for Msg3. In Msg3 the UE transmits its identifier (C-RNTI/ID). The eNB responds to the Msg 3 by acknowledging the UE identifier in Msg 4. The Msg 4 gives contention resolution, i.e. only one UE identifier will be sent even if several UEs have used the same preamble (and Msg 3) simultaneously.

In the 4-step procedure, one of the main usages of the first two messages is to obtain UL time alignment for the UE. In many situations, e.g. in small cells or for stationary UEs, this may not be needed since either a TA=0 will be sufficient (small cells) or a stored TA value from the last RA could serve also for the current RA (stationary UE). In future radio networks it can be expected that these situations are common, both due to dense deployments of small cells and a great number of e.g. stationary IoT devices. A possibility to skip the message exchange to obtain the TA value would lead to reduced RA latency and would be beneficial in several use cases, for example when transmitting infrequent small data packets.

FIG. 1B is a schematic showing a 2-step RA procedure for wireless systems such as LTE and NR Rel-15. The 2-step RA procedure gives much shorter latency than the 4-step RA procedure. As shown in FIG. 1B, the preamble and a message corresponding to Msg 3 in the 4-step RA procedure are transmitted in the same or in two subsequent sub frames (SFs). The Msg3 is sent on a resource dedicated to the specific preamble. This means that both the preamble and the Msg3 face contention but contention resolution in this case means that either both preamble and Msg3 are sent without collision or both collide. Upon successful reception of the preamble and Msg 3, the eNB will respond with a TA (which by assumption should not be needed or just give very minor updates) and a Msg 4 for contention resolution.

Thus, in the 2-step RA procedure the UL messages (PRACH+Msg3) are sent simultaneously and similarly the two DL messages (e.g. time advance command in RAR and contention resolution information) are sent as a simultaneous response in the DL. Therefore, the 2-step RA procedure will consume more resources since it uses contention based transmission of the data. This means that the resources that are configured for the data may often be unused.

If both the four-step and two-step RA are configured in a cell (and for the UE), the UE may choose preamble from one specific set if it wants to do a 4-step RA procedure, or from another set if it wants to do a 2-step RA procedure. Hence a preamble partition can be done to distinguish between 4-step and 2-step RA procedures.

In NR licensed spectrum, both Contention-Based-Random-Access (CBRA) and Contention-Free-Random-Access (CFRA) are supported in a primary cell (PCell). However, only CFRA is allowed in a secondary cell (SCell). In addition, an RAR message is only transmitted in the primary cell. It is mainly due to the restriction of PDCCH search space since the common PDCCH search space (CSS) is only configured in the primary cell.

However, in NR-U, it is beneficial to allow the UE to transmit an RA (both CBRA and CFRA) on either cell to gain additional RA opportunities. Allowing a UE to perform CBRA on an SCell is motivated by several aspects:
An example is a PUCCH SR failure may be triggered by LBT failure in one cell. In this case, the UE has reached the maximum PUCCH SR attempts while the UE has not received UL grant. In NR-U, it may be more often for a UE to occur PUCCH-SR failures due to LBT failure, meaning that it may be more often to trigger RA-SRs than in NR licensed cells. Therefore, it is reasonable for the UE to transmit a CBRA on SCells to gain more RA opportunities.
Another example is a CFRA triggered by a PDCCH order may be blocked by LBT failures in an SCell so that the UE misses the scheduled RA occasion. It would be helpful if the UE is allowed to fallback to CBRA in the same or in a different SCell. The UE then has more chances for that RA to get through.
Yet another example is in case the UE may be subject to LBT for a CBRA beam failure recovery (BFR) RA in the primary cell, the UE can send the RA in other cell to achieve a fast recovery for the beam failure. Thus, the PRACH configuration/resources need to be configured on a secondary cell (or optionally a subset of cells).

Whenever an RA is triggered, the UE may perform LBT on multiple cells and select a cell with a successful LBT to transmit Msg1. After transmission of Msg1, the UE or the gNB may experience LBT failures for subsequent messages in this RA procedure. It would give best flexibility if these messages are allowed to be transmitted cross different cells.

In addition, NR unlicensed operation needs to support both standalone and DC scenarios, which means that both RACH and PUCCH-SR signaling need to be transmitted over unlicensed spectrum cells, since an NR-U cell may operate as a primary cell.

In the next, several embodiments of the disclosure are described in the context of NR unlicensed spectrum (NR-U). However, it shall be understood by one of ordinary skill in the art that the proposed solutions are not limited to NR-U scenarios and are also applicable to other unlicensed operation scenarios, such as LTE LAA/enhanced LAA (eLAA)/Further Enhanced LAA (FeLAA), etc.

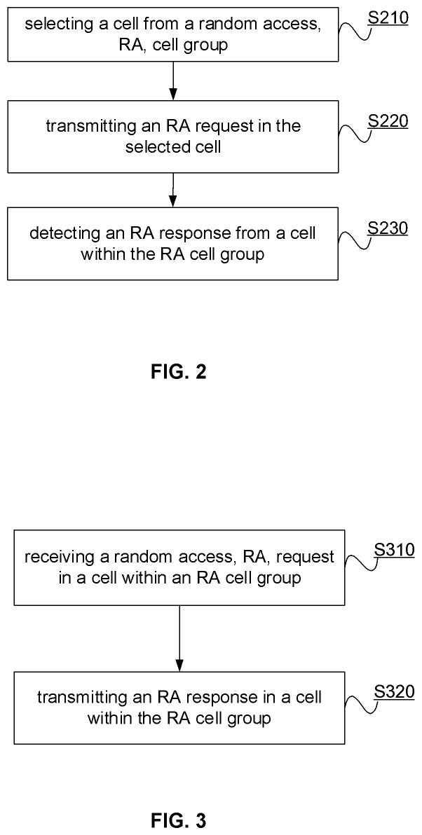

FIG. 2 is a flowchart illustrating a method at a terminal device according to an embodiment of the disclosure.

At block S210, a cell is selected from a random access, RA, cell group. The RA cell group may comprise a number of cells for unlicensed spectrum from which the terminal device to choose for random access. For example, in a carrier aggregation scenario, a number of cells may be configured as the RA cell group. Within the same RA cell group, the terminal device is allowed to transmit a PRACH message on any cell for an RA event, such as RACH-SR, beam failure recovery (BFR) for any cell in the RA cell group, or RA fallback (fallback to CBRA from CFRA), etc.

In an embodiment, the configuration of the RA cell group may be received, for example, from a base station (such as gNB) before the selection. The configuration may be based on at least one of carrier frequency band of cells (e.g., the cells located at the similar frequency bands may be configured into the same group), measurement results of radio channel quality indicators of cells (e.g., cells with similar radio quality may be configured into the same group), and geography locations of cells (e.g., cells collocated or quasi-collocated may be configured into the same group).

In an embodiment, a default RA cell group is configured if the UE is in ‘RRC IDLE’ state, or the RA cell group is configured via dedicated RRC signaling if the UE is in ‘RRC Connected’ state. The default RA cell group comprises a number of cells for unlicensed spectrum from which the terminal device in RRC-idle mode to choose for random access.

In an embodiment, the terminal device may select any of the following cells within the RA cell group:
a cell randomly selected from the RA cell group;
a cell selected according to a predefined order of the cells within the RA cell group;
a cell with best radio quality or with lowest load occupancy;
a cell selected from the RA cell group based on the carrier frequency;
a cell other than the primary cell only if the channel for RA transmission in the primary cell is not available for a certain time; or
a cell within the RA cell group for which future transmission occasion of an RA request comes earliest.

At block S220, an RA request is transmitted in the selected cell.

In an embodiment, if the transmission of the RA request fails, the RA request may be retransmitted after switching to another cell within the RA cell group. In other words, the terminal device may switch to another cell in the same cell group to retransmit an RA message if the terminal device experiences failures for the transmission of an RA message in one cell.

In an embodiment, the terminal device may perform power ramping after switching to the other cell within the RA cell group. For example, if the cell switch is for retransmission of the first message (Msg1), the terminal device may be configured/predefined on whether or not the terminal device shall perform power ramping. In case the power ramping is enabled for cell switch, the terminal device may performs power ramping (e.g. a parameter such as PREAMBLE_TRANSMISSION_COUNTER is gradually increased) after switching to a different cell for retransmission of the first message; otherwise, the terminal device may skip the power ramping.

In an embodiment, the RA request may be retransmitted after switching to another cell within the RA cell group, upon reception of a back off indicator. In this case, the terminal device may skip the back off operation and start the retransmission of the first message immediately on another cell within the RA cell group.

At block S230, an RA response is detected from a cell within the RA cell group by monitoring one or more cells of the RA cell group. The RA response may be an RACH response or Msg4. For example, the terminal device may monitor the RA response in any of the following cells within the RA cell group:
the cell in which the RA request has been transmitted;
a primary cell for the UE and possibly the cell in which the RA request has been transmitted, if the two cells are different;
in each cell configured with a common search space in the RA cell group; or
all of the cells within the RA cell group.

In an embodiment, each cell of the RA cell group may be configured with at least one of PRACH configuration and common search space configuration. In this scenario, one cell within the RA cell group may broadcast the PRACH configuration and/or common search space configuration for all of the cells within the RA cell group, or multiple cells within the RA cell group may broadcast the PRACH configuration and/or common search space configuration for all of the cells within the RA cell group. Thus, the same configurations can be signaled in these cells for duplication purpose. Alternatively, each cell within the RA cell group may signal only its own PRACH configuration and/or common search space configuration, and a cell ID list of the RA cell group can be broadcasted to facilitate a terminal device to identify the RA cell group.

In an embodiment, monitoring an RA response in a cell within the RA cell group may be achieved by stopping the monitoring after detection and successful reception of the first RA response in a cell. Alternatively, the monitoring may be achieved by monitoring, after reception of the first RA response in a cell, other RA responses in other cells until the RA response window expires. Thus the terminal device may receive one or multiple grants (which may be across different cells) carried by the RAR messages. The grants carried by the RA responses may be handled for subsequent transmission by:
selecting the grant in the cell with best radio quality, if a Listen-Before-Talk, LBT, operation succeeds;
selecting the grant corresponding to the earliest transmission of RA request, if the LBT operation succeeds; or
selecting the grant in the primary cell, if the LBT operation succeeds.

In an embodiment, multiple grants may be used to transmit multiple Msg3 messages if the LBT operations for all of the multiple grants succeed. In this case, high priority information may be duplicated in the multiple grants. For example, among those transmitted Msg3 MAC PDUs, the MAC CEs of high priority (such as C-RNTI MAC CE, BSR or PHR) may be duplicated in multiple MAC PDUs. The data from UL CCCH may be also duplicated. The data from any other LCHs can be carried using the free resources in any selected grant.

In an embodiment, Radio Link Failure, RLF, is not triggered even if the maximum number of RA attempts has been reached, provided that there is still other cell available in the RA cell group. In other words, the terminal device would not declare a Random Access problem, which may further trigger an event of RLF, when the maximum RA attempts (i.e., PREAMBLE_TRANSMISSION_COUNTER) has been reached if there is still other cell with RA resources are available in the cell group. Otherwise, the terminal device may trigger an RLF and performs RRC connection establishment. The terminal device may send an RLF report including the information such as indices of all concerned cells of the declared RLF. The RLF report may be carried by an RRC signaling message. The network node can receive such an RLF report and improve cell planning accordingly based on the received RLF report.

In an embodiment, all of the cells in the RA cell group may belong to a same timing advance, TA, group.

In an embodiment, the above concept is also applicable to a scenario where a cell comprises multiple channels or sub-bands (which, for example, has 20 MHz bandwidth) and each channel or sub-band may be configured with PRACH configuration or resources. The PRACH procedure may be completed across different channels or sub-bands. For example, the terminal device may monitor one or several channels or sub-bands for DL PRACH message reception which are linked to one or several channels or sub-bands on which the terminal device has sent a PRACH message in the uplink.

In this way, the cells for uplink RA message transmission and the cells for downlink RA message transmission are linked together. For instance, as soon as an RA Msg1 is transmitted in a cell, the UE can monitor the cells in the same group that are able to receive Msg2, e.g., the cells configured with PDCCH common search space. When the UE transmits Msg3, the UE then monitors the cells that are able to receive the Msg4.

FIG. 3 is a flowchart illustrating a method at a network node according to an embodiment of the disclosure.

At block S310, a random access, RA, request is received in a cell within an RA cell group. The RA cell group comprises a number of cells for unlicensed spectrum from which a terminal device to choose for random access.

In an embodiment, configuration of the RA cell group may be transmitted to the terminal device in advance. The RA cell group may be configured based on at least one of carrier frequency band of cells, measurement results of radio channel quality indicators of cells, and geography locations of cells.

In an embodiment, the RA request may be received in any of the following cells within the RA cell group:
a cell randomly selected from the RA cell group;
a cell selected according to a predefined order of the cells within the RA cell group;
a cell with best radio quality or with lowest load occupancy;
a cell selected from the RA cell group based on the carrier frequency;
a cell other than the primary cell only if the channel for RA transmission in the primary cell is not available for a certain time; or
a cell within the RA cell group for which future transmission occasion of an RA request comes earliest.

In an embodiment, each cell of the RA cell group may be configured with at least one of PRACH configuration and common search space configuration. In this scenario:
one cell within the RA cell group broadcasts the PRACH configuration and/or common search space configuration for all of the cells within the RA cell group;
multiple cells within the RA cell group broadcasts the PRACH configuration and/or common search space configuration for all of the cells within the RA cell group; or
each cell within the RA cell group signals its own PRACH configuration and/or common search space configuration.

At block S320, an RA response is transmitted in a cell within the RA cell group.

In an embodiment, multiple RA responses may be transmitted in different cells in the RA cell group. For example, the multiple RA responses may carry grants with a same size or different sizes.

In an embodiment, multiple Msg3 messages with grants may be received from the terminal device. In this case, high priority information may be duplicated in the grants.

In an embodiment, the network node may receive a Radio Link Failure, RLF, report, and adjust the RA cell group based on the received RLF report.

In an embodiment, all of the cells in the RA cell group belong to a same timing advance, TA, group.

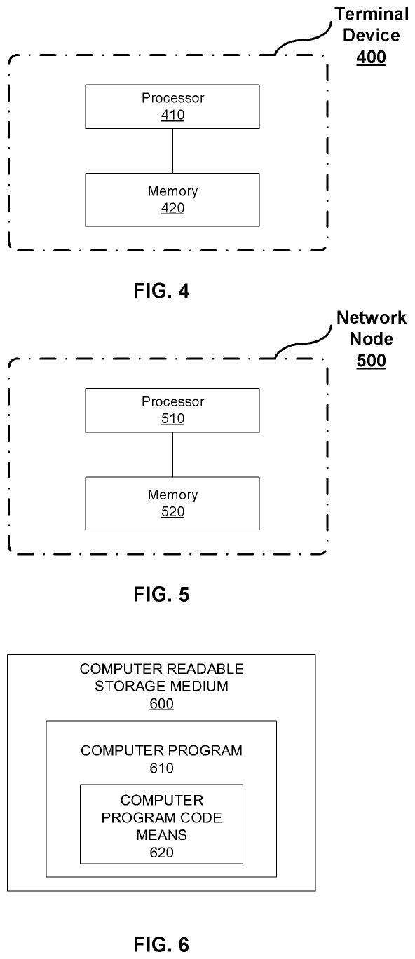

FIG. 4 is a block diagram of a terminal device according to an embodiment of the disclosure. As shown in FIG. 4, the terminal device 400 (such as a UE) may comprise a processor 410 and a memory 420 coupled to the processor 410. The memory 420 contains instructions executable by the processor 410 whereby the terminal device 400 is operative to perform the methods related to the terminal device as have been described above.

The processor 410 may be implemented, for example, by a CPU (Central processing unit), and could also be implemented by other types of devices. For example, the processor 410 may be implemented by one or more general purpose microprocessors, instruction set processors, and/or special purpose microprocessors such as Application Specific Integrated Circuit (ASICs).

The memory 420 may be implemented by various types of storage devices. For example, the memory 420 may be a volatile storage device such as Random Access Memory (RAM). The memory 420 may also be a non-volatile storage device such as Read Only Memory (ROM). One of ordinary skill in the art can envisage that other types of storage devices can be utilized to implement the memory 420.

FIG. 5 is a block diagram of a network node according to an embodiment of the disclosure. As shown in FIG. 5, the network node 500 may comprise a processor 510 and a memory 520 coupled to the processor 510. The memory 520 contains instructions executable by the processor 510 whereby the network node 500 is operative to perform the methods related to the network node as have been described above.

The processor 510 may be implemented, for example, by a CPU (Central processing unit), and could also be implemented by other types of devices. For example, the processor 510 may be implemented by one or more general purpose microprocessors, instruction set processors, and/or special purpose microprocessors such as Application Specific Integrated Circuit (ASICs).

The memory 520 may be implemented by various types of storage devices. For example, the memory 520 may be a volatile storage device such as Random Access Memory (RAM). The memory 520 may also be a non-volatile storage device such as Read Only Memory (ROM). One of ordinary skill in the art can envisage that other types of storage devices can be utilized to implement the memory 520.

The embodiments of the disclosure can be implemented in computer program products. This arrangement of the disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules.

FIG. 6 is a block diagram of a computer readable storage medium having stored thereon a computer program comprising computer program code means according to an embodiment of the disclosure. As shown in FIG. 6, a computer readable medium 600 has stored thereon a computer program 610. The computer program 610 comprises computer program code means 620 for performing, when executed by at least one processor, the methods according to the disclosure as mentioned above. The computer readable medium 600 may have the form of a non-volatile or volatile memory, e.g., an Electrically Erasable Programmable Read-Only Memory (EEPROM), a flash memory, a floppy disk, and a hard drive, etc. The computer program code means 620 may include codes/computer readable instructions in any format.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The terms “first” and “second” refer to different elements. The singular forms “a” and “an” are intended to include the plural forms as well, unless the context clearly indicates otherwise. The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

In addition, language such as the phrase “at least one of X, Y and Z,” unless specifically stated otherwise, is to be understood with the context as used in general to convey that an item, term, etc. may be either X, Y, or Z, or a combination thereof. Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations.

The disclosure has been described with reference to embodiments and drawings. It should be understood that various modifications, alternations and additions can be made by those skilled in the art without departing from the spirits and scope of the disclosure. Therefore, the scope of the disclosure is not limited to the above particular embodiments but only defined by the claims as attached and equivalents thereof.

1. A method at a terminal device, the method comprising:
selecting a cell from a random access, RA, cell group, wherein the RA cell group comprises a number of cells for unlicensed spectrum from which the terminal device to choose for random access;
transmitting a RA request in the selected cell; and
detecting an RA response from another cell within the RA cell group different from the selected cell.

2. The method according to claim 1, further comprising:
receiving configuration of the RA cell group, wherein the configuration is based on at least one of carrier frequency band of cells, measurement results of radio channel quality indicators of cells, and geography locations of cells.

3. The method according to claim 1, further comprising:
switching to another cell within the RA cell group to retransmit the RA request if the transmission of the RA request fails.

4. The method according to claim 3, further comprising:
performing power ramping after switching to the other cell within the RA cell group.

5. The method according to claim 1, further comprising:
switching to another cell within the RA cell group to retransmit the RA request upon reception of a back off indicator.

6. The method according to claim 1, wherein a default RA cell group is configured if the UE is in ‘RRC IDLE’ state, or the RA cell group is configured via dedicated RRC signaling if the UE is in ‘RRC Connected’ state.

7. The method according to claim 1, wherein the selecting a cell from an RA cell group comprises the cell of any of:
a cell randomly selected from the RA cell group;
a cell selected according to a predefined order of the cells within the RA cell group;
a cell with best radio quality or with lowest load occupancy;
a cell selected from the RA cell group based on the carrier frequency;
a cell other than the primary cell only if the channel for RA transmission in the primary cell is not available for a certain time; or
a cell within the RA cell group for which future transmission occasion of an RA request comes earliest.

8. The method according to claim 7, wherein the detecting an RA response comprises monitoring the cell of any of:
a primary cell for the UE;
in each cell configured with a common search space in the RA cell group; or
all of the cells within the RA cell group except for the selected cell.

9. The method according to claim 1, wherein each cell of the RA cell group is configured with at least one of PRACH configuration and common search space configuration.

10. The method according to claim 9,
wherein one cell within the RA cell group broadcasts the PRACH configuration and/or common search space configuration for all of the cells within the RA cell group;
wherein multiple cells within the RA cell group broadcasts the PRACH configuration and/or common search space configuration for all of the cells within the RA cell group; or
wherein each cell within the RA cell group signals its own PRACH configuration and/or common search space configuration.

11. The method according to claim 1, wherein detecting an RA response in another cell within the RA cell group different from the selected cell comprises any of:
stopping monitoring after reception of the first RA response in a cell; or
monitoring, after reception of the first RA response in a cell, other RA responses in other cells until the RA response window expires.

12. The method according to claim 11, wherein grants carried by the RA responses are handled for subsequent transmission by:
selecting the grant in the cell with best radio quality, if a Listen-Before-Talk, LBT, operation succeeds;
selecting the grant corresponding to the earliest transmission of RA request, if the LBT operation succeeds; or
selecting the grant in the primary cell, if the LB T operation succeeds.

13. The method according to claim 11, wherein multiple grants are used to transmit multiple Msg3 messages if the LBT operations for all of the multiple grants succeed.

14. The method according to claim 13, wherein high priority information is duplicated in the multiple grants.

15. The method according to claim 1, wherein Radio Link Failure, RLF, is not triggered even if the maximum number of RA attempts has been reached, provided that there is still other cell available in the RA cell group.

16. The method according to claim 1, wherein all of the cells in the RA cell group belong to a same timing advance, TA, group.

17. A method at a network node, the method comprising:
receiving a random access, RA, request in a cell within an RA cell group, wherein the RA cell group comprises a number of cells for unlicensed spectrum from which a terminal device to choose for random access; and
transmitting an RA response in a cell within the RA cell group.

18. The method according to claim 17, further comprising:
transmitting configuration of the RA cell group to the terminal device.

19. The method according to claim 18, wherein the RA cell group is configured based on at least one of carrier frequency band of cells, measurement results of radio channel quality indicators of cells, and geography locations of cells.

20-27. (canceled)

28. A terminal device, comprising:
one or more processors; and
a memory having stored thereon instructions which, when run on the one or more processors, cause the terminal device to carry out the following acts:
selecting a cell from a random access, RA, cell group, wherein the RA cell group comprises a number of cells for unlicensed spectrum from which the terminal device to choose for random access;
transmitting a RA request in the selected cell; and
detecting an RA response from another cell within the RA cell group different from the selected cell.

29-31. (canceled)
